(19) United States
(12) Patent Application Publication
(10) Pub. No.: US 2006/0105633 A1
(43) Pub. Date: May 18, 2006

(54) Holder for SIM or USIM chip card

(75) Inventors: Michael Richter, Schalksmuhle (DE); Jurgen Bohn, Ludenscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: LUMBERG CONNECT GMBH & CO. KG.

(21) Appl. No.: 11/263,654

(22) Filed: Oct. 31, 2005

(30) Foreign Application Priority Data
Nov. 8, 2004 (DE) 102004054150.7

(51) Int. Cl. H01R 24/00

(52) U.S. Cl. 439/630

(57) ABSTRACT

The holder for a SIM-type chip card has a base having an upper face dimensioned to flatly receive the chip card and an outer edge and contacts exposed at the base upper face. A cover fixed to the base and extending over the upper face forms therewith a slot open toward the base outer edge. This cover is offset inward from the base outer edge and has turned toward the base outer edge an edge region that is elastically deformable upward away from the base upper face. Thus a chip card can be forced into the slot with upward elastic deflection of the cover edge region and substantially no deformation of the chip card.

### FIELD OF THE INVENTION

The present invention relates to a chip-card holder. More particularly this invention concerns a holder for a SIM or USIM card.

### BRIEF DESCRIPTION OF THE DRAWING

In the accompanying drawing:

FIG. 1 shows a perspective view of a prior-art SIN card holder;

FIG. 2 shows a similar view of the prior-art holder of FIG. 1 with a standard SIM card installed in it;

FIGS. 3 and 4 are views like respective FIGS. 1 and 2 showing the card holder of this invention for a USIM card;

FIG. 5 is a larger-scale view of the structure of FIG. 3;

FIG. 6 is a bottom view of the structure of FIG. 5;

FIGS. 7 and 8 are views like respective FIGS. 5 and 6, but with the USIM card installed; and

FIGS. 9, 10, 11, and 12 are views like respective FIGS. 5, 6, 7, and 8 of another USIM card holder according to the invention.

### BACKGROUND OF THE INVENTION

A reader of a chip card typically has a holder in which the card is fitted and that is provided with contacts that engage respective contacts on the card to communicate with the circuitry thereon. In a standard cellular telephone such a holder is mounted in the floor of the battery compartment and holds the SIM (Subscriber Identity Module) card that itself holds the subscriber's information and the data necessary for the subscriber to access his or her network.

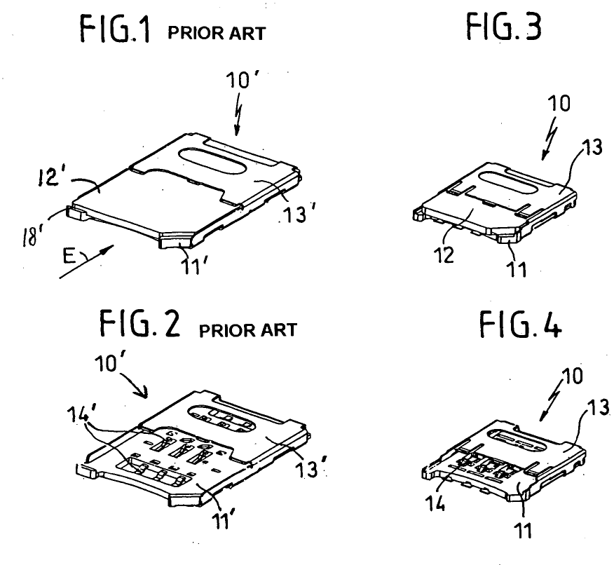

As shown in FIGS. 1 and 2 such a holder 10′ is adapted to hold a standard SIM card 12′ that measures 15 mm wide by 25 mm long. The holder 10′ is comprised of a plastic base 11′ and a metallic cover 13. The card 12′ is inserted in a direction E underneath the short metallic cover 13′ of the holder 10′ and is bent somewhat until it passes the raised front edges 18′ of the base 11′ of the holder 12′ , whereupon it snaps into place, engaging contacts 14′ exposed in holes in the plastic floor of the base 11′ of the holder 10′ . Thus this holder 10′ is of very simple construction, with no moving parts. The SIM card 12′ must be deformed somewhat during installation and removal.

Nowadays cellular phones, which are the most common application for such card holders, are smaller than ever. Thus recourse is had to the new UMTS (Universal Mobile Telecommunication System) format of the USIM or UICC (UMTS Integrated Circuit Card) standard with the chip card measuring only 15 mm by 12 mm. Such a chip is packed more tightly with circuit components so is somewhat more fragile and in particular is less bendable. Thus it is not advisable to use a holder as shown in FIGS. 1 and 2, but instead recourse must be had to more complex and bulkier hinged holders that allow the card to be installed in removed without being deformed.

### OBJECTS OF THE INVENTION

It is therefore an object of the present invention to provide an improved holder for SIM or USIM chip card.

Another object is the provision of such an improved holder for SIM or USIM chip card that overcomes the above-given disadvantages, in particular that has no hinged or pivoted parts, but that can be used to solidly hold the standard small-format USIM cards, and that allows such cards to be removed and reinstalled without damage.

### SUMMARY OF THE INVENTION

The holder for a SIM-type chip card has according to the invention a base having an upper face dimensioned to flatly receive the chip card and an outer edge and contacts exposed at the base upper face. A cover fixed to the base and extending over the upper face forms therewith a slot open toward the base outer edge. This cover is offset inward from the base outer edge and has turned toward the base outer edge an edge region that is elastically deformable upward away from the base upper face. Thus a chip card can be forced into the slot with upward elastic deflection of the cover edge region and substantially no deformation of the chip card.

With this system, the card itself does not deform to any significant extent, but the holder cover does deform elastically to permit the card to be slipped into and out of the slot formed between the cover and the plastic base of the holder. In this manner the holder is still a very simple structure and the elastically deflectable outer edge of the cover can simply be formed by stamping when the cover is made. In fact such a holder is even recommended for standard larger-format SIM cards and the like, which can be damaged by flexing during installation and removal.

The instant invention is easily realized by manufacturing the sheet-metal cover so that its outer edge is elastically deflectable, whereas in the prior art the outer edge is essentially fixed with respect to the base. More particularly, the cover is formed with a plurality of slots extending outward and open toward the base outer edge and defining at least one elastically upwardly deflectable tongue. Two of the slots are at the extreme edges of the cover so that its entire outer edge region can flex upward.

According to the invention the cover is formed with four such slots defining three such tongues, basically formed as simple leaf springs. Two of the tongues are relatively thin side tongues and the other tongue is a center tongue between the side tongues. The center tongue is shorter and wider than the side tongues. Each of the tongues has a U-section turned-up outer edge presenting a smooth surface that can slide on the face of the chip as it is installed and removed so that it will not be scratched or otherwise damaged.

In accordance with the invention the base is raised at the outer edge so that the chip card is captured inward of the raised outer edge. This is useful in a card holder that is not recessed.

### SPECIFIC DESCRIPTION

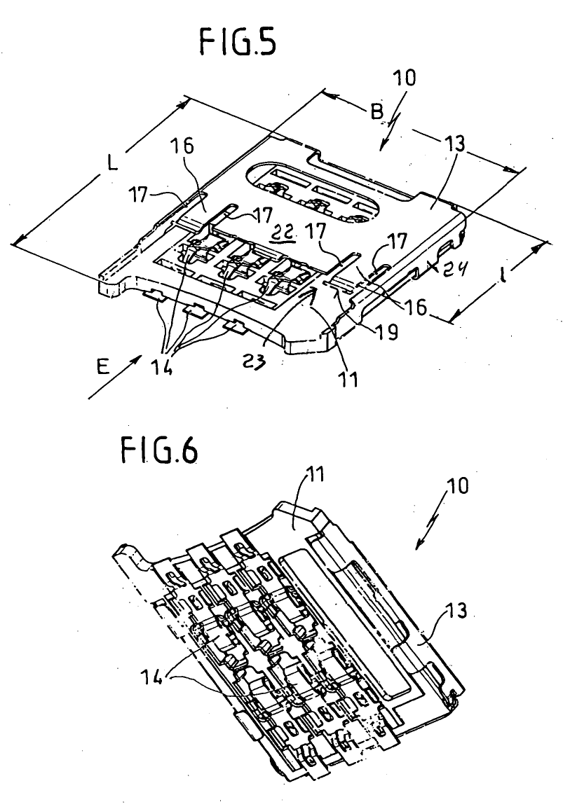

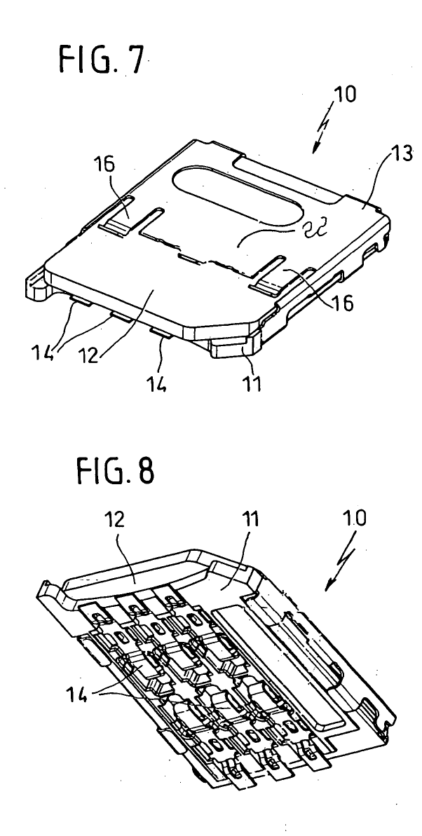

As seen in FIGS. 3 through 8 a holder 10 for a USIM chip 12 is only slightly larger than the 15 mm by 12 mm size of this chip 12. It has a short metal cover 13 and is provided with internal contacts 14 on a dielectric base 11. FIGS. 3 and 4 are to the same scale as respective FIGS. 1 and 2 and clearly illustrate the smaller size of the holder 10 of this invention. The cover 13 forms with the base 11 a rectangular section slot 23 open parallel to the planar upper face of the base 11.

More particularly, FIG. 5 illustrates how the basically rectangular holder 10 has a length L and a width B that are both slightly more than the 15 mm and 12 mm dimensions of the card 12. The cover 11 is of the same width B but has a shorter length l than the length L, here equal to about half L. This leaves the base 11 exposed at one end.

In the embodiment of FIGS. 3-8, the end of the base 11 is flat, with nothing like the raised edge 18′ of FIGS. 1 and 2, so that in theory the card 12 can be slipped in direction E straight in parallel to the plane of the flat base 11. In practice, however, the holder 10 is normally recessed in the floor of a battery compartment with the upper surface of its cover 13 flush with the compartment floor, so that there is no room for such parallel movement.

Thus according to the invention the cover 13 is formed with a pair of slots 17 subdividing its outer third into a pair of relatively long side tongues 16 flanking a somewhat shorter center tongue 22. The tongues 16 are quite elastically deformable so that, when the chip 12 is forced under them, they bend up and allow it to slip into place in the slot 23 under the cover 13, and even the stiffer but shorter center tongue 22 can deform limitedly to allow the chip 12 to fit in without this chip 12 having to deform at all. The center tongue 22 has an outer edge 21 set back from the outer ends of the flanking side tongues 16.

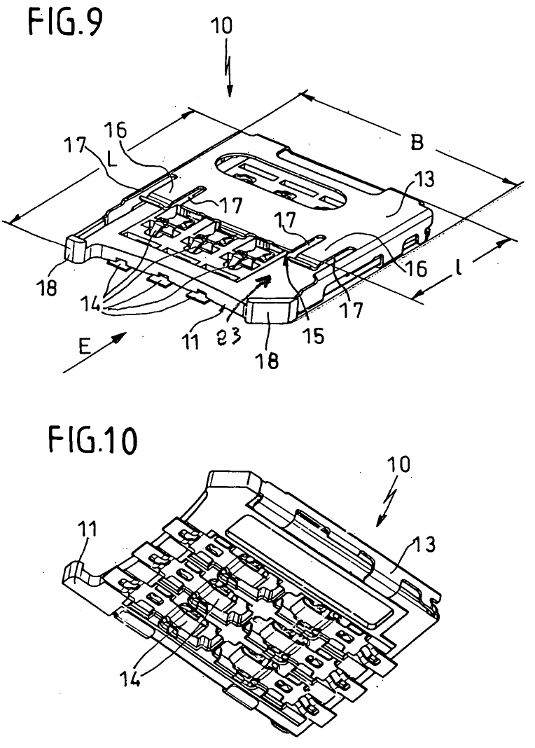

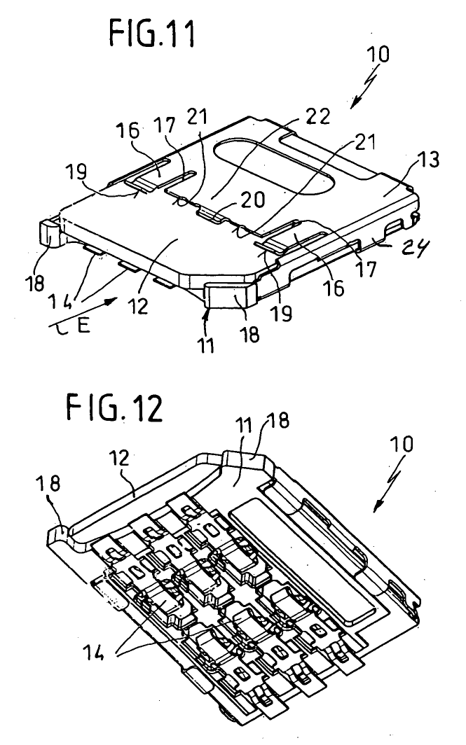

The holder 10 of FIGS. 9 to 12 is identical to that of FIGS. 3 to 8, except that here the base 11 has a raised front edge 18 that captures the chip 12, as in FIGS. 1 and 2. Here also the outer edges of the tongues 16 and 22 are formed with U-shaped feet 19 and 20 that prevent them from digging into the top face of the chip 12. Here also, the cover 13 is formed as a single piece of sheet metal with a flat main panel forming the tongues 16 and 22 and extending parallel to the top face of the chip and side flaps 24 engaged downward and crimped over the edge of the plastic base 11

We claim:

1. In combination with a SIM-type chip card, a holder comprising:
a base having an upper face dimensioned to flatly receive the chip card and an outer edge;
contacts exposed at the base upper face; and
a cover fixed to the base, extending over the upper face and forming therewith a slot open toward the base outer edge, offset inward from the base outer edge, and having turned toward the base outer edge an edge region that is elastically deformable upward away from the base upper face such that a chip card can be forced into the slot with upward elastic deflection of the cover edge region and substantially no deformation of the chip card.

2. The chip-card holder defined in claim 1 wherein the cover is formed with a plurality of slots extending outward and open toward the base outer edge and defining at least one elastically upwardly deflectable tongue.

3. The chip-card holder defined in claim 2 wherein the cover is formed with four such slots defining three such tongues.

4. The chip-card holder defined in claim 3 wherein two of the tongues are relatively thin side tongues and the other tongue is a center tongue between the side tongues.

5. The chip-card holder defined in claim 4 wherein the center tongue is shorter and wider than the side tongues.

6. The chip-card holder defined in claim 4 wherein the center tongue has a U-section turned-up outer edge.

7. The chip-card holder defined in claim 4 wherein the side tongues have U-section turned-up outer edges.

8. The chip-card holder defined in claim 4 wherein the cover is made of thin sheet metal and has top panel extending parallel to the base upper face and forming the tongues and a pair of side flaps extending perpendicularly down and fixed to the base.

9. The chip-card holder defined in claim 1 wherein the base is raised at the outer edge, whereby the chip card is captured inward of the raised outer edge.
